(19) United States
(12) Patent Application Publication
(10) Pub. No.: US 2013/0051759 A1
(43) Pub. Date: Feb. 28, 2013

(54) Time-shifted Telepresence System And Method

(71) Applicant: Evan Scheessele, Corvallis, OR (US)

(72) Inventor: Evan Scheessele, Corvallis, OR (US)

(21) Appl. No.: 13/583,209

(22) PCT Filed: Apr. 27, 2007
(86) PCT No.: PCT/US2007/067662

§ 371 Date: Sep. 6, 2012

(51) Int. Cl. H04N 5/91

(52) U.S. Cl. 386/241; 386/E05.003

(57) ABSTRACT

A time-shifted telepresence system is provided. The system includes a first node. The first node includes prerecorded content. The first node transmits the prerecorded content to a node device in at least one other node during an event in accordance with a meta tag associated with the prerecorded content. The prerecorded content comprises a media recording of a non-present user.

### CROSS-REFERENCE TO RELATED APPLICATIONS

This application is related to copending patent application Ser. No. 11/497886 entitled “System and Method for Managing Virtual Collaboration Systems,” filed on Aug. 2, 2006 and assigned to the same assignee as the present application, the disclosure of which is incorporated herein by reference.

### BACKGROUND

Virtual collaboration systems provide the ability for geographically- dispersed users to facilitate real-time, multimedia communications as if the users were present in the same location. Such systems may be useful when users are spread across distant locations or in situations where travel to a central meeting location is difficult.

A typical virtual collaboration system includes a plurality of nodes connected via a network. Each node may include a plurality of node devices, such as a video input device (e.g., a video camera), a video output device (e.g., a display), an audio input device (e.g., a microphone), and an audio output device (e.g., a speaker). During a virtual meeting, for example, users will typically gather within the nodes and utilize the node devices to facilitate the virtual meeting. Node devices in one node communicate with node devices in other nodes over the network. For example, the video input device in a first node may be connected with the video output device in a second node. In this way, a user in the second node will be able to view video captured in the first node. The captured video essentially provides the user with a visual the user would see if the user was present in the first node.

In certain situations, the user may not be physically present in the node during the virtual meeting. For example, if a virtual meeting occurs in California during California business hours, a user in India may be asleep or otherwise unavailable during the virtual meeting. Incorporating non-present users into a virtual meeting may be necessary for the meeting to occur without incident.

One solution may be to utilize a live actor in place of a non-present user. The actor can read from a script, for example. However, the actor may have no knowledge of the subject, and therefore, may not appreciate the statements, questions, and answers provided by participants of the virtual meeting. Further, the actor may have his or her own communication style that differs from the communication style of the non-present user.

For these and other reasons, there is a need for the present invention.

### SUMMARY

One embodiment provides a time-shifted telepresence system. The system includes a first node. The first node includes prerecorded content. The first node transmits the prerecorded content to a node device in at least one other node during an event in accordance with a meta tag associated with the prerecorded content. The prerecorded content comprises a media recording of a non-present user.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a block diagram of an event in accordance with one embodiment.

FIG. 2 illustrates a flow diagram of a method of inserting prerecorded content into the event.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure's) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As used herein, the term “media” includes text, audio, video, sounds, images, or other suitable digital data capable of being transmitted over a network.

As used herein, the term “node device” includes processor-based devices, input/output devices, or other suitable devices for facilitating communications among remote users. Examples of node devices include fax machines, video cameras, telephones, printers, scanners, displays, personal computers, microphones, and speakers.

As used herein, the term “node” includes any suitable environment or system configured to transmit and/or receive media via one or more node devices. In one embodiment, the environment is a collaborative environment, which enables remote users to share media across one or more node devices. A collaborative environment will enable, for example, a presenter to simultaneously give a multimedia presentation to an audience not only in the presenter's location but also in one or more remote locations. The collaborative environment may further enable the audience in the remote locations to participate in the presentation as the audience in the presenter's location would participate (e.g., ask questions to the presenter).

As used herein, the term “event” refers to a connection of a plurality of nodes such that one or more node devices of one node are configured to transmit media to and/or receive media from one or more node devices of another node.

Embodiments of a time-shifted telepresence system and method are provided. One or more embodiments enable a user who cannot be present in an event to still productively participate in the event. One or more embodiments enable a user who desires not to actively participate in an event to still passively participate in the event. While virtual collaboration systems enable communication over spatial distance, one or more embodiments may enhance virtual collaboration systems, for example, by enabling communication over temporal distance.

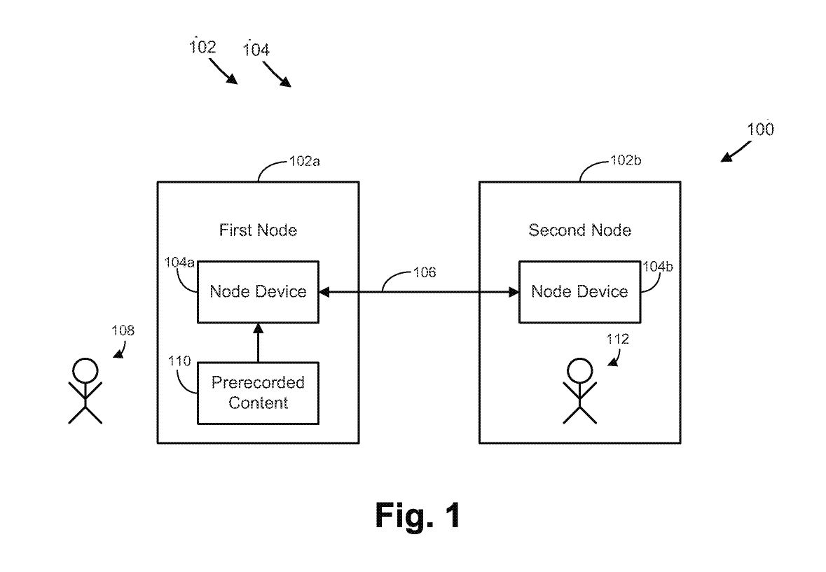

FIG. 1 illustrates a block diagram of an event 100 in accordance with one embodiment. Event 100 includes a first node 102a and a second node 102b (collectively referred to as nodes 102). First node 102a includes a first node device 104a. Second node 102b includes a second node device 104b. First node device 104a and second node device 104b (collectively referred to as node devices 104) communicate via network 106, such as a local area network (LAN) or the Internet. In other embodiments, event 100 includes any suitable number of nodes, and each node includes any suitable number of devices communicating over any suitable number of networks. In one embodiment, nodes 102 are rooms. In one embodiment, node devices 104 may include a media input device, such as a video camera or a microphone, a media output device, such as a display or a speaker, or a combination media input and output device.

Event 100 further includes a non-present user 108, prerecorded content 110, and a live user 112. In one embodiment, non-present user 108 is not physically present at first node 102a during event 100. In another embodiment, non-present user 108 is present at first node 102a but desires not to participate in event 100. Live user 112 is physically present in second node 102b.

Non-present user 108 transmits prerecorded content 110 to live user 112 during event 100. Non-present user 108 utilizes prerecorded content 110 in place of active participation by non-present user 108. In one embodiment, prerecorded content 110 includes prerecorded media of non-present user 108 performing actions non-present user 108 might perform if non-present user 108 was present at first node 102a during event 100. For example, prerecorded content 110 may include prerecorded video of non-present user 108. In one embodiment, each of nodes 102 includes any suitable number of prerecorded contents 110.

In one embodiment, prerecorded content 110 is transmitted to second node device 104b via first node device 104a. In another embodiment, pre-recorded content 110 is transmitted directly to second node device 104b. In one embodiment, second node device 104b outputs prerecorded content 110 for the benefit of live user 112. For example, second node device 104b may display prerecorded content 110 to live user 112.

In one embodiment, non-present user 108 initiates the transmission of prerecorded content 110 during event 100. In another embodiment, a third party initiates the transmission of prerecorded content 110 into event 100. In another embodiment, prerecorded content 110 is automatically transmitted into event 100 in accordance with one or more rules. In one embodiment, the one or more rules are implemented using one or more meta tags associated with prerecorded content 110.

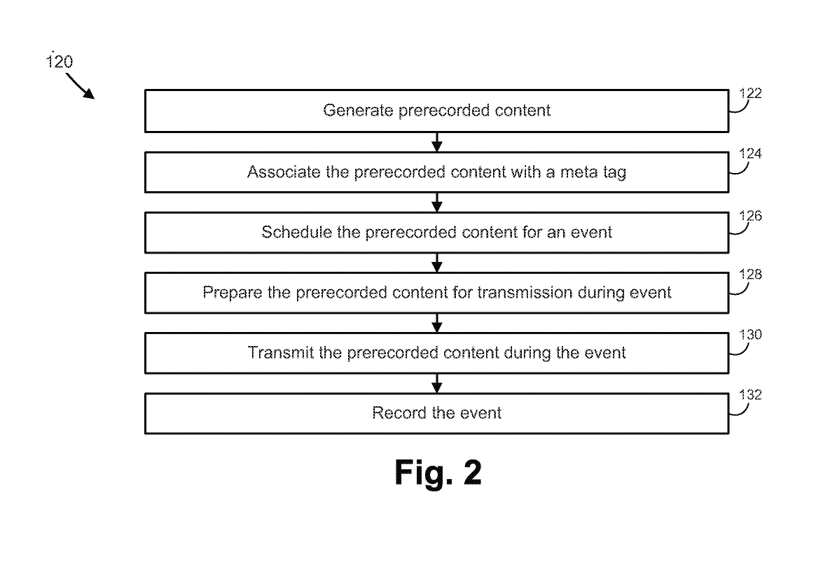

FIG. 2 illustrates a flow diagram of a method 120 of inserting prerecorded content 110 into the event 100. Referring to FIGS. 1 and 2, prerecorded content 110 is generated (at 122). In one embodiment, the prerecorded content 110 is generated by recording media of non-present user 108 in a real or simulated node. In one embodiment, non-present user 108 is recorded performing any suitable actions anticipating the actions non-present user 108 would perform if non-present user 108 was present at first node 102a during event 100. Examples of event actions include introductions, information sharing, direct questions, triggered questions, and conditional answers.

In one embodiment, an introduction is a media presentation introducing a plurality of live users to each other. For example, assume that Ann is a non-present user and that Bob and Charles have not met and are live users. Ann may desire to introduce Bob and Charles to each other during event 100. The introduction may include any suitable information of the live users desired to be shared, including a user's name, age, and job title.

In one embodiment, information sharing is effected by non-present user 108 performing a monologue intended to disseminate information during event 100. The information shared may include any suitable information associated with event 100, such as research findings and financial results.

In one embodiment, a direct question is a question non-present user 108 desires to ask to during event 100 without condition. In one embodiment, a triggered question is a question non-present user 108 desires to ask during the event in response to a conditional occurrence. For example, non-present user 108 may desire to ask a question about the cause of declining sales if declining sales is described by live user 112 during event 100. In one embodiment, a conditional occurrence includes one or more words or phrases.

In one embodiment, a conditional answer is an answer non-present user 108 desires to provide in response to a conditional question asked by live user 112. In one embodiment, the conditional question is a specific question. In another embodiment, the conditional question is a general question about an uncertain subject.

In one embodiment, prerecorded content 110 further includes a passive representation of non-present user 108. Non-present user 108 may anticipate not participating during the entire event 100. The passive representation of non-present user 108 can be shown to live user 112 to simulate non-present user 108 passively participating in event 100. Any number of suitable media segments may be recorded to account for various anticipated situations occurring during event 100. For example, a video segment showing non-present user 108 listening may be recorded. For another example, a video segment showing non-present user 108 thinking may be recorded.

In one embodiment, different media segments are recorded for the same situation and interchanged accordingly. In one embodiment, media segments are recorded to show non-present user 108 expressing a number of different emotions. In one embodiment, different media segments are recorded to account for different positions of live user 112. For example, different video segments may account for different lines of sight of a standing live user 112 versus a sitting live user 112. In one embodiment, one or more media segments are looped during the passive representation of non-present user 108 during event 100.

Prerecorded content 110 is associated (at 124) with one or more meta tags enforcing one or more rules regarding prerecorded content 110. In one embodiment, the meta tag represents a condition. For example, the meta tag may be used to associate a conditional occurrence to a triggered question, such that receiving the conditional occurrence causes the transmission of the triggered question. For another example, the meta tag may be used to associate a conditional answer to a conditional question, such that receiving the conditional question causes the transmission of the conditional answer.

In one embodiment, the meta tag represents a directive. In one embodiment, a directive is an instruction related to temporally inserting prerecorded content 110 into event 100. For example, the directive may instruct that prerecorded content 110 is to be transmitted at the beginning of event 100.

In one embodiment, the meta tag represents a response expectation. In one embodiment, a response expectation is an instruction to expect a response. For example, prerecorded content 110 containing a direct question or a triggered question may be tagged with a response expectation, which causes the node to record the expected response.

In one embodiment, the meta tag represents a logical order to be followed when transmitting a plurality of prerecorded contents. For example, a logical order may dictate that a triggered question be followed after performing a particular direct question and receiving a particular response. In one embodiment, the logical order is defined to follow natural conversation patterns.

In other embodiments, meta tags are used to enforce any suitable rules or protocols. For example, meta tags may be used to enforce limits in a negotiation. For another example, meta tags may be used to enforce limits in an interrogation.

Prerecorded content 110 is scheduled (at 126) for event 100. In one embodiment, non-present user 108 registers for event 100 as if non-present user 108 is going to be present at event 100. That is, non-present user 108 does not inform other users of event 100 of the absence of non-present user 108 during event 100. In another embodiment, non-present user 108 registers for event 100 indicating that non-present user 108 will not be present at event 100.

Prerecorded content 110 is prepared (at 128) for transmission during event 100. In one embodiment, prerecorded content 110 is transferred to local caching servers closer to the nodes receiving pre-content 110. Utilizing local cache servers may reduce delay, especially if prerecorded content 110 includes bandwidth-heavy media. In another embodiment, conditions associated with the event are verified. For example, a triggered question may be associated with a conditional occurrence whereby a certain live user makes a statement. In this case, the presence of the certain live user during event 100 may be verified.

Prerecorded content 110 is transmitted (at 130) during event 100. In one embodiment, prerecorded content 110 is manually inserted by a third party. In one embodiment, the third party is not visible to live user 112. As event 100 progresses, the third party inserts prerecorded content 110 in accordance with its meta tags. In one embodiment, the third party controls the insertion of prerecorded content 110 using a console in first node 102a. In another embodiment, prerecorded content 110 is manually inserted by non-present user 108.

In another embodiment, prerecorded content 110 is automatically inserted in accordance with the associated meta tags. In one embodiment, a suitable speech recognition system is utilized to recognize speech from live user 112. In one embodiment, a suitable eye gaze recognition system is utilized to quantify, recognize, and track the eye gaze of live user 112. In one embodiment, a suitable artificial intelligence or fuzzy logic system is utilized to determine the best opportunity to initiate the transmission of prerecorded content 110 based on one or more of the meta tags, the recognized speech, and the recognized eye gaze.

In one embodiment, non-present user 108 utilizes prerecorded content 110 while simultaneously screening event 100. That is, non-present 108 is physically present at first node 102a during event 100 but provides the impression of being absent to live user 112. In this way, non-present user 108 can choose to enter event 100 in place of prerecorded content 110 if non-present user 108 so chooses. The ability to screen event 100 may be useful for users who have discomfort in meetings, poor attentiveness, language barriers, and the like.

In one embodiment, live user 112 utilizes prerecorded content 110 to replace the presence of live user 112 during event 100. In this way, live user 112 can physically leave second node 102b while still providing the impression of participation in event 100.

In one embodiment, event 100 is recorded (at 132). Event 100 may be recorded on any suitable digital storage medium, such as a hard drive. In one embodiment, the recorded event is stored for later access by non-present user 108 or other parties. In one embodiment, the recorded event includes only the participation of live users 112, effectively omitting prerecorded content 110.

Embodiments described and illustrated with reference to the Figures provide time-shifted telepresence systems and methods. It is to be understood that not all components and/or steps described and illustrated with reference to the Figures are required for all embodiments. In one embodiment, one or more of the illustrative methods are preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A time-shifted telepresence system, comprising:
a first node comprising prerecorded content;
wherein the first node transmits the prerecorded content to a node device in at least one other node during an event in accordance with a meta tag associated with the prerecorded content;
wherein the prerecorded content comprises a media recording of a non-present user.

2. The telepresence system of claim 1, wherein the prerecorded content comprises prerecorded video of the non-present user.

3. (cancelled)

4. The telepresence system of claim 1, wherein the prerecorded content is transmitted to the node device over a network.

5. (canceled)

6. (canceled)

7. (canceled)

8. (canceled)

9. The telepresence system of claim 1, wherein the non-present user screens the event by transmitting the prerecorded content.

10. The telepresence system of claim 1, wherein the meta tag comprises a directive instructing the first node to transmit the prerecorded content at a given time during the event.

11. The telepresence system of claim 1, wherein the meta tag comprises a conditional occurrence resulting in the first node transmitting the prerecorded content.

12. (canceled)

13. (canceled)

14. The telepresence system of claim 1, wherein the meta tag enforces a logical order of the prerecorded content.

15. The telepresence system of claim 1, wherein the prerecorded content comprises a passive representation of the non-present user.

16. The telepresence system of claim 1, further comprising a speech recognizer for recognizing speech from the at least one other node, wherein the first node transmits the prerecorded content to the node device during the event based on the meta tag and the recognized speech.

17. The telepresence system of claim 1, further comprising an eye gaze recognizer for recognizing an eye gaze from another user in the at least one other node, wherein the first node transmits the prerecorded content to the node device during the event based on the meta tag and the recognized eye gaze.

18. (canceled)

19. The telepresence system of claim 1, wherein the event is a virtual collaboration.

20. The telepresence system of claim 1, wherein the first node comprises a virtual collaboration meeting room.

21. A method of inserting prerecorded content into an event, comprising:
generating the prerecorded content comprising media of a non--present user;
associating the prerecorded content with a meta tag; and
transmitting the prerecorded content from a first node to at least one other node during the event in accordance with the meta tag.

22. The method of claim 13, further comprising:
recording the event.

23. The method of claim 13, wherein generating the prerecorded content comprises recording video of the non-present user.

24. The method of claim 13, wherein generating the prerecorded content comprises recording the non-present user giving a monologue sharing information.

25. (canceled)

26. (canceled)

27. (canceled)

28. The method of claim 13, wherein generating the prerecorded content comprises recording a passive representation of the non-present user.

29. (canceled)

30. The method of claim 13, wherein associating the prerecorded content with a meta tag comprises associating the prerecorded content with a conditional occurrence, wherein receiving the conditional occurrence results in transmitting the prerecorded content.

31. (canceled)

32. (canceled)

33. The method of claim 13, wherein associating the prerecorded content with a meta tag comprises associating the prerecorded content with at least one rule enforcing a logical order of the prerecorded content.

34. A machine-readable medium having instructions stored thereon for execution by a processor to perform a method of inserting prerecorded content into an event, the method comprising:
generating the prerecorded content comprising media of a non-present user;
associating the prerecorded content with a meta tag; and
transmitting the prerecorded content from a first node to at least one other node during the event in accordance with the meta tag.
